(19) United States
(12) Patent Application Publication
(10) Pub. No.: US 2026/0065639 A1
(43) Pub. Date: Mar. 5, 2026

(54) FACE IMAGE CLUSTERING METHOD AND APPARATUS, ELECTRONIC DEVICE, AND STORAGE MEDIUM

(71) Applicant: BEIJING LONGZHI DIGITAL TECHNOLOGY CO., LTD., Beijing (CN)

(72) Inventors: Zhao JIANG, Beijing (CN); Zeyuan HUANG, Beijing (CN); Xiaoting QI, Beijing (CN); Zhanbo YANG, Beijing (CN)

(73) Assignee: BEIJING LONGZHI DIGITAL TECHNOLOGY CO., LTD., Beijing (CN)

(21) Appl. No.: 19/107,054

(22) PCT Filed: Nov. 2, 2022
(86) PCT No.: PCT/CN2022/129333

§ 371 Date: Feb. 27, 2025

(30) Foreign Application Priority Data
Aug. 30, 2022 (CN) 202211046423.8

(51) Int. Cl. G06V 10/762; G06V 10/774; G06V 10/82; G06V 40/16

(52) U.S. Cl. CPC G06V 10/7635; G06V 10/774; G06V 10/82; G06V 40/168

(57) ABSTRACT

A face image clustering method and apparatus, an electronic device, and a storage medium are provided. The method includes: performing feature extraction on samples in a face data set by using a face recognition model to obtain a feature; calculating a cosine distance between each two features, and constructing a connected graph covering all the samples; on the basis of a connected component, searching the connected graph to obtain low-level subgraphs, and aggregating the low-level subgraphs, to obtain first candidate clusters; calculating quality scores and intersection scores, and screening the first candidate clusters to obtain second candidate clusters; outputting probability values of vertexes in the second candidate clusters by using a graph convolutional neural network, and removing noise points to obtain third candidate clusters; and searching for a shared vertex between each of the other third candidate clusters and a reference cluster, and removing the shared vertex.

### CROSS REFERENCE TO THE RELATED APPLICATIONS

This application is the national phase entry of International Application No. PCT/CN2022/129333, filed on Nov. 2, 2022, which is based upon and claims priority to Chinese Patent Application No. 202211046423.8, filed on Aug. 30, 2022, the entire contents of which are incorporated herein by reference.

### TECHNICAL FIELD

The present application relates to the field of face recognition technologies, and in particular, to a face image clustering method and apparatus, an electronic device, and a storage medium.

### BACKGROUND

With a development of a face recognition technology, training is required to be performed through a lot of data to obtain a high-precision model, the data is relatively easy to collect, but annotation requires a large amount of manpower, and therefore, it is considered to use label-free data to improve a face recognition effect, and an intuitive method includes clustering the label-free data to generate pseudo labels, and then directly throwing the data into a supervised model.

However, existing clustering methods, such as K-means clustering, spectral clustering, hierarchical clustering, or the like, all rely on many assumptions; for example, the K-means clustering has an initial assumption that a clustering center exists, but actually, this assumption may be wrong (e.g., manifold distribution), the spectral clustering requires class distribution balance, such that, due to these assumptions, the clustering methods cannot be applied to complex clustering scenarios and tend to generate clusters with much noise. In addition, in a large-scale face image clustering task, complex distribution is a main problem, and when processing the complex distribution, the existing clustering method tends to generate a plurality of noisy clusters.

Therefore, the existing face image clustering algorithm has the problems that the existing face image clustering algorithm cannot be applied to the complex clustering scenario and is prone to generate the noisy clusters to reduce a face image clustering effect.

### SUMMARY

In view of this, embodiments of the present application provide a face image clustering method and apparatus, an electronic device, and a storage medium, so as to solve the problems in the prior art that an existing face image clustering method cannot be applied to a complex clustering scenario and is prone to generate noisy clusters to reduce a face image clustering effect.

In a first aspect of the embodiments of the present application, there is provided a face image clustering method, including: acquiring a face data set used for clustering, and performing feature extraction on samples in the face data set by using a trained face recognition model to obtain a feature corresponding to each sample; calculating a corresponding cosine distance between each two features of the samples, and by using each sample as a vertex and using the cosine distance as a link, constructing a connected graph covering all the samples; on the basis of a connected component, searching the connected graph to obtain low-level subgraphs meeting a predetermined condition, and aggregating the low-level subgraphs, to obtain first candidate clusters; calculating a quality score and an intersection score corresponding to each first candidate cluster by using a graph convolutional neural network, and according to the quality scores, screening the first candidate clusters to obtain second candidate clusters; using the second candidate clusters as an input of the graph convolutional neural network, outputting probability values corresponding to vertexes in the second candidate clusters, and according to the probability values, removing noise points in the second candidate clusters to obtain third candidate clusters; and using the third candidate cluster having the highest intersection score as a reference cluster, searching for a shared vertex between each of the other third candidate clusters and the reference cluster, removing the shared vertexes in the other third candidate clusters, and using the reference cluster and the other third candidate clusters subjected to removal of the shared vertexes as face image clustering results corresponding to the face data set.

In a second aspect of the embodiments of the present application, there is provided a face image clustering apparatus, including: a feature extracting module configured to acquire a face data set used for clustering, and perform feature extraction on samples in the face data set by using a trained face recognition model to obtain a feature corresponding to each sample; a connected graph constructing module configured to calculate a corresponding cosine distance between each two features of the samples, and by using each sample as a vertex and using the cosine distance as a link, construct a connected graph covering all the samples; a searching and aggregating module configured to, on the basis of a connected component, search the connected graph to obtain low-level subgraphs meeting a predetermined condition, and aggregate the low-level subgraphs, to obtain first candidate clusters; a candidate cluster screening module configured to calculate a quality score and an intersection score corresponding to each first candidate cluster by using a graph convolutional neural network, and according to the quality scores, screen the first candidate clusters to obtain second candidate clusters; a noise point removing module configured to use the second candidate clusters as an input of the graph convolutional neural network, output probability values corresponding to vertexes in the second candidate clusters, and according to the probability values, remove noise points in the second candidate clusters to obtain third candidate clusters; and a shared vertex removing module configured to use the third candidate cluster having the highest intersection score as a reference cluster, search for a shared vertex between each of the other third candidate clusters and the reference cluster, remove the shared vertexes in the other third candidate clusters, and use the reference cluster and the other third candidate clusters subjected to removal of the shared vertexes as face image clustering results corresponding to the face data set.

In a third aspect of the embodiments of the present application, there is provided an electronic device, including a memory, a processor and a computer program stored on the memory and runnable on the processor, wherein the processor, when executing the program, implements the steps of the above method.

In a fourth aspect of the embodiments of the present application, there is provided a computer-readable storage medium storing a computer program, wherein the computer program, when executed by a processor, implements the steps of the above method.

At least one of the above technical solutions adopted in the embodiments of the present application can achieve the following beneficial effects.

The face data set used for clustering is acquired, and the feature extraction is performed on the samples in the face data set by using the trained face recognition model to obtain the feature corresponding to each sample; the corresponding cosine distance between each two features of the samples is calculated, and by using each sample as the vertex and using the cosine distance as the link, the connected graph covering all the samples is constructed; on the basis of the connected component, the connected graph is searched to obtain the low-level subgraphs meeting the predetermined condition, and the low-level subgraphs are aggregated, to obtain the first candidate clusters; the quality score and the intersection score corresponding to each first candidate cluster are calculated by using the graph convolutional neural network, and according to the quality scores, the first candidate clusters are screened to obtain the second candidate clusters; the second candidate clusters are used as the input of the graph convolutional neural network, the probability values corresponding to the vertexes in the second candidate clusters are output, and according to the probability values, the noise points in the second candidate clusters are removed to obtain the third candidate clusters; and the third candidate cluster having the highest intersection score is used as the reference cluster, the shared vertex between each of the other third candidate clusters and the reference cluster is searched for, the shared vertexes in the other third candidate clusters are removed, and the reference cluster and the other third candidate clusters subjected to removal of the shared vertexes are taken as the face image clustering results corresponding to the face data set. The face image clustering method according to the present application can be applied to the complex clustering scenario, and avoid generating the noisy clusters to improve the face image clustering effect.

### BRIEF DESCRIPTION OF THE DRAWINGS

In order to more clearly illustrate the technical solutions in the embodiments of the present application, the accompanying drawings used in the description of the embodiments or the prior art will be briefly introduced below. It is apparent that, the accompanying drawings in the following description are only some embodiments of the present application, and other drawings can be obtained by those of ordinary skill in the art from the provided drawings without creative efforts.

FIG. 1 is a schematic flowchart of a face image clustering method according to an embodiment of the present application;

FIG. 2 is a schematic structural diagram of a graph convolutional neural network in an embodiment of the present application;

FIG. 3 is a schematic structural diagram of a face image clustering apparatus according to an embodiment of the present application; and

FIG. 4 is a schematic structural diagram of an electronic device according to an embodiment of the present application.

### DETAILED DESCRIPTION OF THE EMBODIMENTS

In the following description, for the purpose of illustration instead of limitation, specific details such as a particular system structure and a technology are provided to make the embodiments of the present application understood thoroughly. However, it should be understood by those skilled in the art that the present application can also be implemented in other embodiments without the specific details. In other cases, detailed description of well-known systems, apparatuses, circuits and methods is omitted, so that the present application is described without being impeded by unnecessary details.

As described in the BACKGROUND, with a development of a face recognition technology, training is required to be performed through a lot of data to obtain a high-precision model, the data is relatively easy to collect, but annotation requires a large amount of manpower, and therefore, it is considered to use label-free data to improve a face recognition effect, and an intuitive method includes clustering the label-free data to generate pseudo labels, and then directly throwing the data into a supervised model.

However, existing clustering methods, such as K-means clustering, spectral clustering, hierarchical clustering, or the like, all rely on many assumptions; for example, the K-means clustering has an initial assumption that a clustering center exists, but actually, this assumption may be wrong (e.g., manifold distribution), the spectral clustering requires class distribution balance, such that, due to these assumptions, the clustering methods cannot be applied to complex clustering scenarios and tend to generate clusters with much noise. In particular, in a large-scale face image clustering task, complex distribution is a main problem, and when processing the complex distribution, the existing face image clustering method tends to generate a plurality of noisy clusters.

Since a graph convolutional neural network (GCN) is expansion of a traditional convolutional neural network (CNN) for processing graph structural data, and the GCN has a strong complex graph modeling capacity, in the present application, the GCN is combined to divide a face image clustering problem into a candidate cluster detection problem and a segmentation problem, a large number of original clusters can be obtained through candidate cluster detection, noise points in the candidate clusters are then removed through a segmentation model, and finally, clustered clusters are obtained.

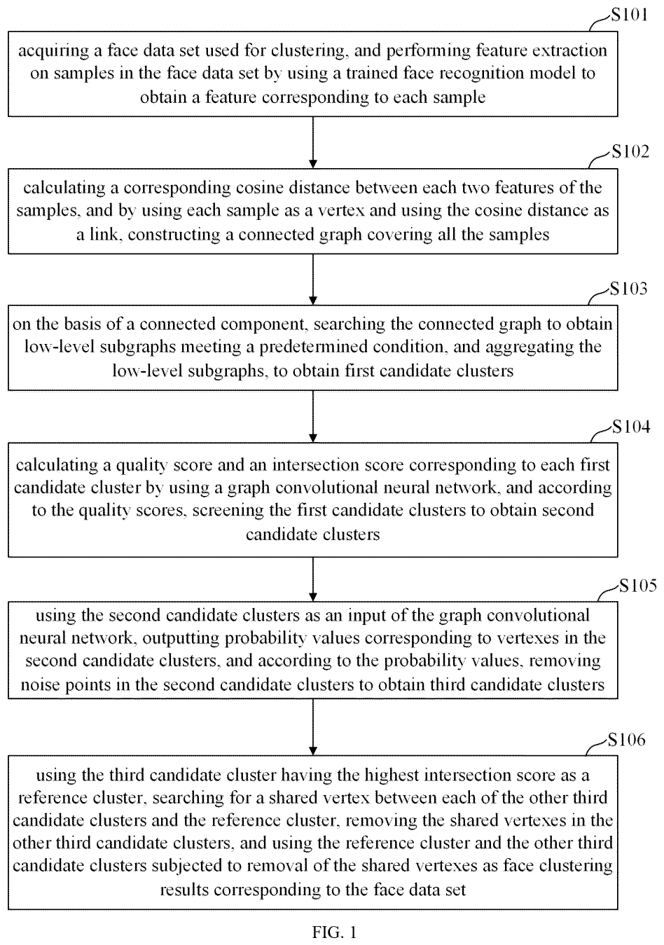

FIG. 1 is a schematic flowchart of a face image clustering method according to an embodiment of the present application. The face image clustering method of FIG. 1 may be performed by a server. As shown in FIG. 1, the face image clustering method may specifically include:
S101: acquiring a face data set used for clustering, and performing feature extraction on samples in the face data set by using a trained face recognition model to obtain a feature corresponding to each sample;
S102: calculating a corresponding cosine distance between each two features of the samples, and by using each sample as a vertex and using the cosine distance as a link, constructing a connected graph covering all the samples;
S103: on the basis of a connected component, searching the connected graph to obtain low-level subgraphs meeting a predetermined condition, and aggregating the low-level subgraphs, to obtain first candidate clusters;
S104: calculating a quality score and an intersection score corresponding to each first candidate cluster by using a graph convolutional neural network, and according to the quality scores, screening the first candidate clusters to obtain second candidate clusters;
S105: using the second candidate clusters as an input of the graph convolutional neural network, outputting probability values corresponding to vertexes in the second candidate clusters, and according to the probability values, removing noise points in the second candidate clusters to obtain third candidate clusters; and
S106: using the third candidate cluster having the highest intersection score as a reference cluster, searching for a shared vertex between each of the other third candidate clusters and the reference cluster, removing the shared vertexes in the other third candidate clusters, and using the reference cluster and the other third candidate clusters subjected to removal of the shared vertexes as face image clustering results corresponding to the face data set.

Specifically, the face data set of the embodiment of the present application includes a large number of samples, and each sample corresponds to one face image; for example, the face data set includes hundreds of thousands or millions of face images. The face image clustering method according to the embodiment of the present application includes the following six parts: extracting the features of the face image, constructing the original graph, obtaining the candidate subgraphs through a detection module, selecting the high-quality candidate subgraphs based on the GCN, eliminating the noise points in the high-quality candidate subgraphs through a segmentation module, and removing intersection parts between the candidate subgraphs. Contents of the six parts will be described in detail below with reference to specific embodiments.

In some embodiments, the performing feature extraction on samples in the face data set by using a trained face recognition model to obtain a feature corresponding to each sample includes: pre-training a face recognition model by using collected public data to obtain a pre-trained face recognition model; extracting a preset number of samples from the face data set for annotation, and performing secondary training on the pre-trained face recognition model by using the annotated samples to obtain a secondarily-trained face recognition model; and performing feature extraction on the residual samples in the face data set by using the secondarily-trained face recognition model to obtain the feature corresponding to each sample.

Specifically, the extraction of the face features of the embodiment of the present application is crucial to face image clustering, effective face features can obtain a better clustering result, and therefore, when the face feature corresponding to each sample (face image) in the face data set is extracted, firstly, one face recognition model is pre-trained by using the collected public data, a certain number of samples (for example, 50,000 face images) are extracted from data to be clustered (i.e., the face data set) for annotation, the pre-trained face recognition model is then trained using the annotated data (that is, secondary training is performed on the pre-trained face recognition model), and feature extraction is performed on the residual samples in the face data set by the secondarily-trained face recognition model, thereby obtaining the face feature corresponding to each sample.

Further, in the embodiment of the present application, after feature extraction is performed on all the samples in an original data set (the face data set), the cosine distance between the features corresponding to each sample is calculated, an original graph (i.e., the connected graph) is then constructed, and a construction method of the connected graph includes: taking each sample as the vertex of the connected graph; taking the calculated cosine distance between the sample features as the link of the connected graph, only nearest k vertexes being selected for each vertex when the link is constructed; and finally obtaining the connected graph containing all the samples.

In some embodiments, the on the basis of a connected component, searching the connected graph to obtain low-level subgraphs meeting a predetermined condition includes: removing links with the cosine distances lower than a set threshold in the connected graph, acquiring a connected subgraph from the connected graph based on the connected graph with the links removed and the connected component, removing the connected subgraph from the connected graph, and storing the connected graph with the connected subgraph removed into a list; and taking a graph with a vertex number lower than a fixed threshold in the connected subgraphs as the low-level subgraph, gradually increasing the set threshold according to a preset threshold step until the connected graph with the connected subgraph removed stored in the list is empty, and obtaining all the low-level subgraphs.

Specifically, in the embodiment of the present application, when the candidate subgraph is obtained through the detection module, since the detection module refers to the idea of a detection algorithm, a large number of proposals (i.e., candidate clusters) may be generated. The generation of the candidate cluster mainly includes: a first step of generate the low-level subgraph and a second step of generating a high-level subgraph; the following describes contents of the two steps of the generation of the candidate clusters in detail with reference to specific embodiments.

Further, the low-level subgraph contains a small fraction of vertexes which are similar to each other, and thus can be replaced by the connected component, but if the connected component is derived directly from the original graph (i.e., the connected graph), a number of the low-level subgraphs is particularly large. Therefore, in order to maintain high connectivity with other subgraphs, in the embodiment of the present application, the connecting links below a certain threshold are removed, and a number of the vertexes of the connected subgraph is forced to be less than a certain value, thereby generating the low-level subgraph. The following describes the generation process and principle of the low-level subgraph in detail with reference to a specific embodiment, which may specifically include the following contents.

It is assumed that the constructed connected graph is A, that is, A is the original graph, and R is configured to store the graph obtained after the connected subgraph is removed from the connected graph A, and can be regarded as a list or data storage structure in practical applications, and the connected graph with the connected subgraph removed is stored into the list R;
firstly, the links with the cosine distances lower than a threshold in the connected graph are removed, and then, a plurality of connected subgraphs are derived through the connected component in the connected graph with the links removed; that is, in each step, the link lower than the threshold is first removed from the connected graph A, and then, the connected subgraph generated after the link is removed is obtained;
secondly, the connected subgraphs are searched for the graphs with node numbers (i.e., vertex numbers) lower than the fixed threshold T, the found graphs are taken as the low-level subgraphs, the threshold is then gradually increased, the above operation is repeated until the list R is empty, and the searching is finished.

It should be noted that a maximum connected subgraph of an undirected graph G is referred to as the connected component of G. Any connected graph has only one connected component, i.e., itself, and an unconnected undirected graph has multiple connected components. In the embodiment of the present application, the connected graph is searched for the connected subgraphs according to the connected components, such that one connected component can correspond to one connected subgraph, and all the found connected subgraphs are used as the low-level subgraphs.

In some embodiments, the aggregating the low-level subgraphs, to obtain first candidate clusters includes: determining a central vertex corresponding to each low-level subgraph, taking the central vertexes of the low-level subgraphs as the vertexes and connections between the central vertexes as the links, and aggregating the low-level subgraphs to obtain high-level subgraphs; searching for the connected component based on the aggregated high-level subgraph to obtain a new connected subgraph, performing a next aggregation iteration based on the new connected subgraph to obtain a new high-level subgraph, and storing the high-level subgraph and the new high-level subgraph as the first candidate cluster.

Specifically, after all the low-level subgraphs are found, the low-level subgraphs are still too conservative compared with the required candidate clusters, and although one low-level subgraph is likely to belong to the same person, samples of the same person may belong to different low-level subgraphs respectively, and with the inspiration of multi-scale proposals in target detection, a higher-level graph is constructed on the low-level subgraph in the present application, and in the process of constructing the high-level subgraph, in the embodiment of the present application, the center of the low-level subgraph is used as the vertex, the connection between the vertexes is used as the link, and after repeated use, the large number of multi-scale candidate clusters can be obtained.

Further, assuming that there are three low-level subgraphs A, B and C, when the low-level subgraphs are aggregated to obtain the high-level subgraph, a central vertex corresponding to each subgraph is first determined, the central vertex being obtained by averaging all the vertexes in the low-level subgraph; the central vertexes of the low-level subgraphs A, B and C are taken as vertexes of the high-level subgraph, connections between the central vertexes are taken as links, and according to such an operation, through one iteration, some low-level subgraphs can be merged into the high-level subgraph;
after the high-level subgraphs are obtained through a first iteration, connected components are continuously searched for on the high-level subgraphs to obtain new connected subgraphs, central vertexes of the new connected subgraphs are continuously calculated, aggregation is continuously carried out based on the central vertexes, the operation is repeated, new high-level subgraphs can be obtained after two iterations, and finally, all the high-level subgraphs generated in the iteration process are stored as the first candidate clusters.

It should be noted that, in the embodiment of the present application, the large number of multi-scale candidate clusters are obtained through the iteration operation of aggregating and finding the connected components, and in practical applications, a number of iterations of aggregating and finding the connected components may be two or more, and the specific number of the iterations may be determined according to actual requirements.

In some embodiments, the calculating a quality score and an intersection score corresponding to each first candidate cluster by using a graph convolutional neural network, and according to the quality scores, screening the first candidate clusters to obtain second candidate clusters includes: inputting the first candidate clusters into the graph convolutional neural network, and calculating the quality score and the intersection score corresponding to each first candidate cluster by using the graph convolutional neural network; and screening the first candidate clusters according to the quality score corresponding to each first candidate cluster and a preset quality score threshold, and taking the first candidate clusters corresponding to the quality scores higher than the quality score threshold as the second candidate clusters, the graph convolutional neural network being abbreviated as GCN.

Specifically, after all the candidate subgraphs (i.e., the first candidate clusters) are obtained through the detection module, in the embodiment of the present application, a high-quality graph is selected based on the GCN. The GCN which actually has a same role as the CNN can be considered as a feature extractor, but an object of the GCN is graph data. The GCN subtly designs a method for extracting features from the graph data, such that these features can be used to perform node classification, graph classification, and link prediction on the graph data, a graph embedding representation can also be obtained incidentally, the following describes calculation steps and a principle of the GCN, and calculation of the GCN mainly includes the following three steps:
first step: sending each node, transforming feature information of the nodes, and then transmitting the feature information to neighbor nodes, in this step, the feature information of the nodes being extracted and transformed;
second step: receiving each node, and gathering the feature information of the neighbor nodes, in this step, local structure information of the nodes being fused; that is, the information of the nodes and all the adjacent nodes being fused; and
third step: performing transformation, and performing nonlinear transformation after the previous information is gathered, which increases an expression capability of the model.

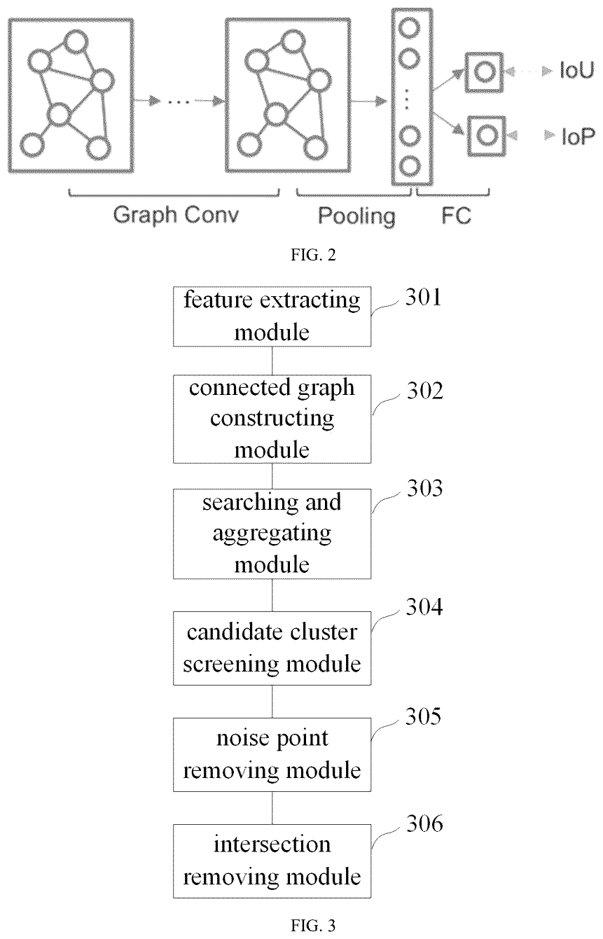

Through the above processing of the GCN, the large number of candidate clusters can be obtained, and since the GCN has a strong information aggregation capability, the GCN is adopted in the present application to select the high-quality candidate graph from the high-level subgraphs (i.e., the first candidate clusters). The following describes in detail the process of screening out the high-quality candidate graph using the GCN in conjunction with a structural diagram of the GCN in the embodiment of the present application, and FIG. 2 is a schematic structural diagram of the GCN in the embodiment of the present application. As shown in FIG. 2, the process of screening out the high-quality candidate graph using the GCN may specifically include:
inputting each first candidate cluster into the GCN to calculate scores thereof (including the quality score and the intersection score); a training process of the GCN in the embodiment of the present application includes: giving a training set with class labels to obtain a ground-truth IoU score (intersection score) and IoP score (quality score), and then training the GCN by a mean square error (MSE); an inference process thereof includes predicting the IoU score and IoP score of each proposal (first candidate cluster) by the trained GCN; the IoP score is used to decide whether a certain proposal is required to be refined, that is, required to be subjected to noise point removal, the IoU score is used to remove an intersection part between the proposals, and the higher the IoU score is, the more the intersection part is required to be removed.

Further, when calculating the score, the GCN in the embodiment of the present application uses the following formula:

$${F}_{l - 1} ( {𝒫}_{i} ) = σ ( {\tilde{D} ( {𝒫}_{i} )}^{- 1} ( A ( {𝒫}_{i} ) + I ) {F}_{l} ( {𝒫}_{i} ) {W}_{l} ) \\ IoU ( 𝒫 ) = \frac{\vert 𝒫 ⋂ \hat{𝒫 \vert}}{\vert 𝒫 ⋃ \hat{𝒫 \vert}} , IoU ( 𝒫 ) = \frac{\vert 𝒫 ⋂ \hat{𝒫 \vert}}{\vert 𝒫 \vert}$$

wherein the IoP score is also called a candidate cluster score, the higher the IoP score is, the higher the quality of the candidate cluster is, the candidate cluster with the IoP score larger than the quality score threshold is selected as the high-quality candidate graph, and noise points of the high-quality candidate graph are removed.

In some embodiments, the using the second candidate clusters as an input of the graph convolutional neural network, outputting probability values corresponding to vertexes in the second candidate clusters, and according to the probability values, removing noise points in the second candidate clusters to obtain third candidate clusters includes: inputting the second candidate clusters into the graph convolutional neural network, and calculating the probability value corresponding to each vertex in each second candidate cluster by using the graph convolutional neural network; taking the vertex with the probability value lower than a threshold as the noise point, removing the noise point from the second candidate cluster, and taking the second candidate cluster with the noise point removed as the third candidate cluster; the probability value is used for representing a probability that the vertex is not the noise point, and the higher the probability value is, the more the vertex is not the noise point.

Specifically, after the high-quality candidate graph is selected, in the embodiment of the present application, the noise points in the high-quality candidate graph are eliminated by the segmentation module. After the foregoing processing, the generated candidate clusters are still impure, and therefore, in the embodiment of the present application, the segmentation module based on a GCN is constructed to remove outliers therein.

When the outliers are defined, in a normal method, all vertexes with different labels are set as outliers, but this method does not work well when all the vertexes in one cluster essentially have half-and-half labels. Therefore, in order to prevent the manually-parameter-adjusted defined outliers from encouraging the model to learn different segmentation modes, in the embodiment of the present application, one vertex is randomly selected as a seed multiple times, such that multiple training samples are obtained for each candidate cluster.

Further, since the GCN used in eliminating the noise points in the high-quality candidate graph has the same structure as the GCN used in screening out the high-quality candidate graph, the structure of the GCN is not repeated, and a main difference lies in a value to be predicted; the GCN here is not used to predict the quality score of the whole candidate cluster, but rather outputs one probability value for each vertex v in the candidate cluster, and the probability value indicates the possibility that the vertex is a true member rather than an outlier (i.e., noise point).

A training process of the GCN of the embodiment of the present application includes: randomly selecting one vertex from the candidate cluster as the seed, and considering vertexes with the same label as the seed as positive vertexes and other vertexes as the outliers. This solution is applied multiple times using the randomly selected seed, such that multiple training samples can be obtained from each candidate cluster, and then, training is performed with cross entropy as a loss function.

Further, the probability value corresponding to each vertex in each second candidate cluster is output by the trained GCN, the probability value represents the probability that the vertex is not a noise point (i.e., outlier), and an inference process of the GCN aims to retain a prediction result with most positive vertexes (the threshold is 0.5).

In some embodiments, the using the third candidate cluster having the highest intersection score as a reference cluster, searching for a shared vertex between each of the other third candidate clusters and the reference cluster, and removing the shared vertexes in the other third candidate clusters includes: sorting the third candidate clusters according to the intersection scores, using the third candidate cluster having the highest intersection score as the reference cluster, and reserving the reference cluster; and according to the sorting result, sequentially comparing each of the other third candidate clusters with the reference cluster, determining the shared vertex between each of the other third candidate clusters and the reference cluster, taking the shared vertexes as intersection parts between the other third candidate clusters and the reference cluster, and removing the intersection parts from the other third candidate clusters.

Specifically, after the outliers in the second candidate clusters are removed, in the embodiment of the present application, the intersection parts between the candidate subgraphs are removed with a modified NMS algorithm (that is, the clusters at the intersection parts are separated). The following describes the operation of removing the intersection parts with the NMS algorithm with reference to a specific embodiment, which may specifically include the following contents:
since the third candidate clusters may intersect with each other, that is, have shared vertexes, which may cause a confronting result in face recognition, the embodiment of the present application proposes the modified NMS algorithm, including: first ranking the third candidate clusters according to the IoU scores (intersection scores), retaining the third candidate cluster with the highest IoU score as a candidate cluster with highest reliability (that is, as the reference cluster), sequentially comparing each of the other third candidate clusters with the reference cluster according to the IoU scores, checking the shared vertexes of each of the other third candidate clusters and the reference cluster, and finally removing the shared vertexes in the other third candidate clusters to obtain the candidate clusters with the intersection parts removed.

That is, the NMS algorithm of the embodiment of the present application has a basic principle that a rank is obtained according to the IoU scores (intersection scores) in a reverse order, the proposals are then collected from the rank, and finally, the vertexes owned by the previous clusters are gradually removed from top to bottom.

According to the technical solution of the embodiment of the present application, the face image clustering method according to the embodiment of the present application has the following advantages:
(1) the present application provides a face image clustering algorithm based on the detection module and the segmentation module by analyzing an existing clustering algorithm, and the clustering algorithm can process more complex clustered data, such that a large amount of data for face recognition can be generated;
(2) the present application provides the detection module based on the existing detection algorithm idea, and the module can generate the large number of candidate graphs from the original connected graph and can further fuse the candidate graphs to obtain the high-level candidate graph;
(3) the present application constructs the segmentation module based on the GCN, the module outputs one score for each vertex in the candidate graph, the score indicates the possibility that the vertex is the real member rather than the outlier, and the outlier in the candidate graph can be removed through processing of the module.

An apparatus according to the embodiments of the present application is described below, and may be configured to perform the method according to the embodiments of the present application. For details not disclosed in the embodiments of the apparatus according to the present application, reference is made to the embodiments of the method according to the present application.

FIG. 3 is a schematic structural diagram of a face image clustering apparatus according to an embodiment of the present application. As shown in FIG. 3, the face image clustering apparatus includes:
a feature extracting module 301 configured to acquire a face data set used for clustering, and perform feature extraction on samples in the face data set by using a trained face recognition model to obtain a feature corresponding to each sample;
a connected graph constructing module 302 configured to calculate a corresponding cosine distance between each two features of the samples, and by using each sample as a vertex and using the cosine distance as a link, construct a connected graph covering all the samples;
a searching and aggregating module 303 configured to, on the basis of a connected component, search the connected graph to obtain low-level subgraphs meeting a predetermined condition, and aggregate the low-level subgraphs, to obtain first candidate clusters;
a candidate cluster screening module 304 configured to calculate a quality score and an intersection score corresponding to each first candidate cluster by using a graph convolutional neural network, and according to the quality scores, screen the first candidate clusters to obtain second candidate clusters;
a noise point removing module 305 configured to use the second candidate clusters as an input of the graph convolutional neural network, output probability values corresponding to vertexes in the second candidate clusters, and according to the probability values, remove noise points in the second candidate clusters to obtain third candidate clusters; and
a shared vertex removing module 306 configured to use the third candidate cluster having the highest intersection score as a reference cluster, search for a shared vertex between each of the other third candidate clusters and the reference cluster, remove the shared vertexes in the other third candidate clusters, and take the reference cluster and the other third candidate clusters subjected to removal of the shared vertexes as face image clustering results corresponding to the face data set.

In some embodiments, the feature extracting module 301 of FIG. 3: pre-trains a face recognition model by using collected public data to obtain a pre-trained face recognition model; extracts a preset number of samples from the face data set for annotation, and performs secondary training on the pre-trained face recognition model by using the annotated samples to obtain a secondarily-trained face recognition model; and performs feature extraction on the residual samples in the face data set by using the secondarily-trained face recognition model to obtain the feature corresponding to each sample.

In some embodiments, the searching and aggregating module 303 of FIG. 3: removes links with the cosine distances lower than a set threshold in the connected graph, acquires a connected subgraph from the connected graph based on the connected graph with the links removed and the connected component, removes the connected subgraph from the connected graph, and stores the connected graph with the connected subgraph removed into a list; and takes a graph with a vertex number lower than a fixed threshold in the connected subgraphs as the low-level subgraph, gradually increases the set threshold according to a preset threshold step until the connected graph with the connected subgraph removed stored in the list is empty, and obtains all the low-level subgraphs.

In some embodiments, the searching and aggregating module 303 of FIG. 3: determines a central vertex corresponding to each low-level subgraph, takes the central vertexes of the low-level subgraphs as the vertexes and connections between the central vertexes as the links, and aggregates the low-level subgraphs to obtain high-level subgraphs; searches for the connected component based on the aggregated high-level subgraph to obtain a new connected subgraph, performs a next aggregation iteration based on the new connected subgraph to obtain a new high-level subgraph, and stores the high-level subgraph and the new high-level subgraph as the first candidate cluster.

In some embodiments, the candidate cluster screening module 304 of FIG. 3: inputs the first candidate clusters into the graph convolutional neural network, and calculates the quality score and the intersection score corresponding to each first candidate cluster by using the graph convolutional neural network; and screens the first candidate clusters according to the quality score corresponding to each first candidate cluster and a preset quality score threshold, and takes the first candidate clusters corresponding to the quality scores higher than the quality score threshold as the second candidate clusters, the graph convolutional neural network being abbreviated as GCN.

In some embodiments, the noise point removing module 305 of FIG. 3: inputs the second candidate clusters into the graph convolutional neural network, and calculates the probability value corresponding to each vertex in each second candidate cluster by using the graph convolutional neural network; takes the vertex with the probability value lower than a threshold as the noise point, removes the noise point from the second candidate cluster, and takes the second candidate cluster with the noise point removed as the third candidate cluster; the probability value is used for representing a probability that the vertex is not the noise point, and the higher the probability value is, the more the vertex is not the noise point.

In some embodiments, the shared vertex removing module 306 of FIG. 3: sorts the third candidate clusters according to the intersection scores, takes the third candidate cluster with the highest intersection score as the reference cluster, and reserves the reference cluster; and according to the sorting result, sequentially compares each of the other third candidate clusters with the reference cluster, determines the shared vertex between each of the other third candidate clusters and the reference cluster, takes the shared vertexes as intersection parts between the other third candidate clusters and the reference cluster, and removes the intersection parts from the other third candidate clusters.

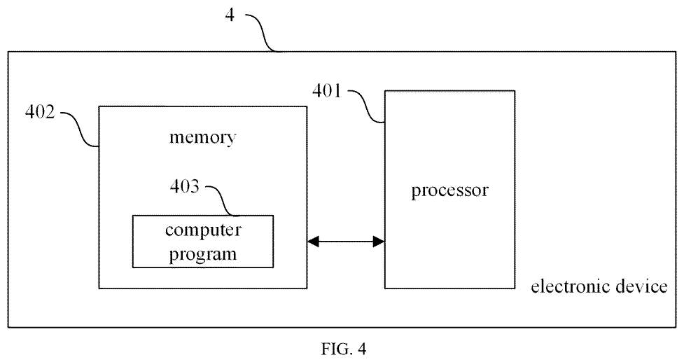

FIG. 4 is a schematic structural diagram of an electronic device 4 according to an embodiment of the present application. As shown in FIG. 4, the electronic device 4 according to the present embodiment includes: a processor 401, a memory 402, and a computer program 403 stored in the memory 402 and executable on the processor 401. The steps in the various method embodiments described above are implemented when the processor 401 executes the computer program 403. Alternatively, the processor 401 achieves the functions of each module/unit in each apparatus embodiment described above when executing the computer program 403.

Exemplarily, the computer program 403 may be partitioned into one or more modules/units, which are stored in the memory 402 and executed by the processor 401 to complete the present application. One or more of the modules/units may be a series of computer program instruction segments capable of performing specific functions, the instruction segments describing the execution of the computer program 403 in the electronic device 4.

The electronic device 4 may be a desktop computer, a notebook, a palm computer, a cloud server or another electronic device. The electronic device 4 may include, but is not limited to, the processor 401 and the memory 402. Those skilled in the art may understand that a structure shown in FIG. 4 is only an example of the electronic device 4 and does not limit the electronic device 4, which may include more or fewer components than those shown in the drawings, or some components may be combined, or a different component deployment may be used. For example, the electronic device may further include an input/output device, a network access device, a bus, or the like.

The processor 401 may be a Central Processing Unit (CPU), or other general-purpose processors, Digital Signal Processors (DSP), Application Specific Integrated Circuits (ASIC), Field-Programmable Gate Arrays (FPGA) or other programmable logic devices, discrete gates or transistor logic devices, discrete hardware components, etc. The general-purpose processor may be a microprocessor or the processor may be any general processor, or the like.

The memory 402 may be an internal storage unit of the electronic device 4, for example, a hard disk or memory of the electronic device 4. The memory 402 may also be an external storage device of the electronic device 4, such as a plug-in hard disk, a Smart Media Card (SMC), a Secure Digital (SD) Card, a Flash Card, or the like, configured on the electronic device 4. Further, the memory 402 may also include both the internal storage unit and the external storage device of the electronic device 4. The memory 402 is configured to store the computer program and other programs and data required by the electronic device. The memory 402 may be further configured to temporarily store data which has been or will be outputted.

It may be clearly understood by those skilled in the art that, for convenient and brief description, division of the above functional units and modules is used as an example for illustration. In practical application, the above functions can be allocated to different functional units and modules and implemented as required; that is, an internal structure of the apparatus is divided into different functional units or modules to accomplish all or some of the functions described above. The functional units or modules in the embodiments may be integrated into one processing unit, or each of the units may exist alone physically, or two or more units are integrated into one unit, and the integrated unit may be implemented in a form of hardware, or may also be implemented in a form of a software functional unit. In addition, specific names of all the functional units or modules are merely for facilitating the differentiation, but are not intended to limit the protection scope of this application. For a specific working process of the units or modules in the above system, reference may be made to the corresponding process in the foregoing method embodiments, which is not repeated herein.

In the above embodiments, the description of each embodiment has its own emphasis. For a part not described in detail in one embodiment, reference may be made to relevant description of other embodiments.

Those of ordinary skill in the art would appreciate that the units and algorithmic steps of the examples described in combination with the embodiments disclosed herein can be implemented by electronic hardware or a combination of computer software and electronic hardware. Whether these functions are performed by hardware or software depends on a specific application and design constraints of the technical solution. Technical professionals may achieve the described functions in different methods for each particular application, but such implementation should not be considered beyond the scope of the present application.

In the embodiments of the present application, it is to be understood that the disclosed apparatus/computer device and method can be implemented in other ways. For example, the embodiment of the apparatus/computer device described above is merely schematic. For example, the division of the modules or units is merely logical function division, and there may be other division manners in an actual implementation. For example, a plurality of units or components may be combined or integrated into another system, or some features may be ignored or not performed. In addition, the displayed or discussed mutual coupling or direct coupling or communication connection may be implemented by using some interfaces. The indirect coupling or communication connection between apparatuses or units may be implemented in an electric form, a mechanical form, or other forms.

The units described as separate parts may or may not be physically separate, and parts displayed as units may or may not be physical units, may be located at one position, or may be distributed on a plurality of network units. Some or all of the units may be selected according to actual needs to achieve the objectives of the solutions of the embodiments.

In addition, the functional units in the embodiments of the present application may be integrated into one processing unit, or each of the units may exist alone physically, or two or more units are integrated into one unit. The integrated unit may be implemented in a form of hardware or in a form of a software functional unit.

The integrated module/unit may be stored in a computer-readable storage medium when implemented in the form of the software functional unit and sold or used as a separate product. Based on such understanding, all or some of the processes in the method according to the above embodiments may be realized in the present application, or completed by the computer program instructing related hardware, the computer program may be stored in the computer-readable storage medium, and when the computer program is executed by the processor, the steps of the above method embodiments may be realized. The computer program may include a computer program code, which may be in a form of a source code, an object code or an executable file or in some intermediate forms. The computer-readable medium may include any entity or apparatus capable of carrying the computer program code, a recording medium, a USB flash drive, a removable hard disk, a magnetic disk, an optical disk, a computer memory, a Read-Only Memory (ROM), a Random Access Memory (RAM), an electrical carrier signal, a telecommunication signal, a software distribution medium, and so on. It should be noted that content included in the computer-readable medium may be appropriately increased or decreased according to requirements of legislation and patent practice in a jurisdiction, for example, in some jurisdictions, according to legislation and patent practice, the computer-readable medium does not include the electrical carrier signal and the telecommunication signal.

The above embodiments are merely intended to describe the technical solutions of the present application, but not to limit the present application. Although the present application is described in detail with reference to the foregoing embodiments, those of ordinary skill in the art should understand that they may still make modifications to the technical solutions described in the foregoing embodiments or make equivalent replacements to some technical features thereof. Such modifications or replacements do not cause the essence of the corresponding technical solutions to depart from the spirit and scope of the technical solutions of the embodiments of the present application, and should be included in the protection scope of the present application.

What is claimed is:

1. A face image clustering method, comprising:
acquiring a face data set configured for clustering, and performing a feature extraction on samples in the face data set by using a trained face recognition model to obtain a feature corresponding to each of the samples;
calculating a cosine distance between each two features of the samples, and by using each of the samples as a vertex and using the cosine distance as a link, and constructing a connected graph covering all the samples;
on a basis of a connected component, searching the connected graph to obtain low-level subgraphs meeting a predetermined condition, and aggregating the low-level subgraphs, to obtain first candidate clusters;
calculating a quality score and an intersection score corresponding to each of the first candidate clusters by using a graph convolutional neural network, and according to the quality scores, screening the first candidate clusters to obtain second candidate clusters;
using the second candidate clusters as an input of the graph convolutional neural network, outputting probability values corresponding to vertexes in the second candidate clusters, and according to the probability values, removing noise points in the second candidate clusters to obtain third candidate clusters; and
using the third candidate cluster having a highest intersection score as a reference cluster, searching for a shared vertex between each of other third candidate clusters and the reference cluster, removing the shared vertexes in the other third candidate clusters, and using the reference cluster and the other third candidate clusters subjected to a removal of the shared vertexes as face image clustering results corresponding to the face data set.

2. The face image clustering method according to claim 1, wherein the step of performing the feature extraction on the samples in the face data set by using the trained face recognition model to obtain the feature corresponding to each of the samples comprises:
pre-training a face recognition model by using collected public data to obtain a pre-trained face recognition model;
extracting a preset number of the samples from the face data set for an annotation to obtain annotated samples, and performing a secondary training on the pre-trained face recognition model by using the annotated samples to obtain a secondarily-trained face recognition model; and
performing the feature extraction on residual samples in the face data set by using the secondarily-trained face recognition model to obtain the feature corresponding to each of the samples.

3. The face image clustering method according to claim 1, wherein the step of on the basis of the connected component, searching the connected graph to obtain the low-level subgraphs meeting the predetermined condition comprises:
removing links with the cosine distances lower than a set threshold in the connected graph, acquiring a connected subgraph from the connected graph based on the connected graph with the links removed and the connected component, removing the connected subgraph from the connected graph, and storing the connected graph with the connected subgraph removed into a list; and
taking a graph with a vertex number lower than a fixed threshold in the connected subgraphs as the low-level subgraph, gradually increasing the set threshold according to a preset threshold step until the connected graph with the connected subgraph removed stored in the list is empty, and obtaining all the low-level subgraphs.

4. The face image clustering method according to claim 1, wherein the step of aggregating the low-level subgraphs, to obtain the first candidate clusters comprises:
determining a central vertex corresponding to each of the low-level subgraphs, taking the central vertexes of the low-level subgraphs as vertexes and connections between the central vertexes as links, and aggregating the low-level subgraphs to obtain aggregated high-level subgraphs; and
searching for the connected component based on the aggregated high-level subgraph to obtain a new connected subgraph, performing a next aggregation iteration based on the new connected subgraph to obtain a new high-level subgraph, and storing the aggregated high-level subgraph and the new high-level subgraph as the first candidate cluster.

5. The face image clustering method according to claim 1, wherein the step of calculating the quality score and the intersection score corresponding to each of the first candidate clusters by using the graph convolutional neural network, and according to the quality scores, screening the first candidate clusters to obtain the second candidate clusters comprises:
inputting the first candidate clusters into the graph convolutional neural network, and calculating the quality score and the intersection score corresponding to each of the first candidate clusters by using the graph convolutional neural network; and
screening the first candidate clusters according to the quality score corresponding to each of the first candidate clusters and a preset quality score threshold, and taking the first candidate clusters corresponding to the quality scores higher than the preset quality score threshold as the second candidate clusters, and the graph convolutional neural network being abbreviated as a graph convolutional neural network.

6. The face image clustering method according to claim 1, wherein the step of using the second candidate clusters as the input of the graph convolutional neural network, outputting the probability values corresponding to the vertexes in the second candidate clusters, and according to the probability values, removing the noise points in the second candidate clusters to obtain the third candidate clusters comprises:
inputting the second candidate clusters into the graph convolutional neural network, and calculating the probability value corresponding to each of the vertexes in each of the second candidate clusters by using the graph convolutional neural network; and
taking the vertex with the probability value lower than a threshold as the noise point, removing the noise point from the second candidate cluster, and taking the second candidate cluster with the noise point removed as the third candidate cluster;
wherein the probability value is configured for representing a probability that the vertex is not the noise point, and when the probability value is increased, the vertex is not the noise point more and more.

7. The face image clustering method according to claim 1, wherein the step of using the third candidate cluster having the highest intersection score as the reference cluster, searching for the shared vertex between each of the other third candidate clusters and the reference cluster, and removing the shared vertexes in the other third candidate clusters comprises:
sorting the third candidate clusters according to the intersection scores, using the third candidate cluster having the highest intersection score as the reference cluster, and reserving the reference cluster; and
according to a sorting result, sequentially comparing each of the other third candidate clusters with the reference cluster, determining the shared vertex between each of the other third candidate clusters and the reference cluster, taking the shared vertexes as intersection parts between the other third candidate clusters and the reference cluster, and removing the intersection parts from the other third candidate clusters.

8. A face image clustering apparatus, comprising:
a feature extracting module configured to acquire a face data set configured for clustering, and perform a feature extraction on samples in the face data set by using a trained face recognition model to obtain a feature corresponding to each of the samples;
a connected graph constructing module configured to calculate a cosine distance between each two features of the samples, and by using each of the samples as a vertex and using the cosine distance as a link, and construct a connected graph covering all the samples;
a searching and aggregating module configured to, on a basis of a connected component, search the connected graph to obtain low-level subgraphs meeting a predetermined condition, and aggregate the low-level subgraphs, to obtain first candidate clusters;
a candidate cluster screening module configured to calculate a quality score and an intersection score corresponding to each of the first candidate clusters by using a graph convolutional neural network, and according to the quality scores, screen the first candidate clusters to obtain second candidate clusters;
a noise point removing module configured to use the second candidate clusters as an input of the graph convolutional neural network, output probability values corresponding to vertexes in the second candidate clusters, and according to the probability values, remove noise points in the second candidate clusters to obtain third candidate clusters; and
a shared vertex removing module configured to use the third candidate cluster having a highest intersection score as a reference cluster, search for a shared vertex between each of other third candidate clusters and the reference cluster, remove the shared vertexes in the other third candidate clusters, and use the reference cluster and the other third candidate clusters subjected to a removal of the shared vertexes as face image clustering results corresponding to the face data set.

9. An electronic device, comprising a memory, a processor, and a computer program stored on the memory and runnable on the processor, wherein the processor, when executing the computer program, implements the face image clustering method according to claim 1.

10. A computer-readable storage medium storing a computer program, wherein the computer program, when executed by a processor, implements the face image clustering method according to claim 1.
